(19) United States
(12) Patent Application Publication
(10) Pub. No.: US 2007/0268240 A1
(43) Pub. Date: Nov. 22, 2007

(54) Display device and method of driving the display device

(76) Inventors: Sang-Jin Lee, Suwon-si (KR); Su-Joung Kang, Suwon-si (KR); Jin-Ho Lee, Suwon-si (KR); Kyung-Sun Ryu, Suwon-si (KR); Kyu-Won Jung, Suwon-si (KR); Jong-Hoon Shin, Suwon-si (KR); Pil-Goo Jun, Suwon-si (KR)

Correspondence Address: CHRISTIE, PARKER & HALE, LLP, PO BOX 7068, PASADENA, CA, 91109-7068, US

(21) Appl. No.: 11/708,989

(22) Filed: Feb. 20, 2007

(30) Foreign Application Priority Data
May 19, 2006 (KR) 10-2006-0045225
Sep. 7, 2006 (KR) 10-2006-0086145
Oct. 25, 2006 (KR) 10-2006-0104085

(51) Int. Cl. G09G 3/36

(52) U.S. Cl. 345/102

(57) ABSTRACT

A display device includes a display panel assembly having a plurality of pixels arranged in rows and columns and a backlight unit disposed behind the display panel assembly and having a plurality of pixels arranged in rows and columns. The number of the pixels of the backlight unit is less than a number of the pixels of the display panel assembly. The backlight unit includes a plurality of scan electrodes arranged along one of row and column directions and a plurality of data electrodes arranged along the other of the row and column directions; and the pixels of the backlight unit are adapted to emit lights having intensities in accordance with gray levels of the pixels of the display panel assembly.

### CROSS-REFERENCES TO RELATED APPLICATIONS

This application claims priority to and the benefit of Korean Patent Application Nos. 10-2006-0045225, 10-2006-0086145, and 10-2006-0104085 filed in the Korean Intellectual Property Office on May 19, 2006, Sep. 7, 2006, Oct. 25, 2006, respectively, the entire content of all of which is incorporated herein by reference.

### BACKGROUND OF THE INVENTION

1. Field of the Invention

The present invention relates to a display device, and more particularly, to a display device including a backlight unit that operates in synchronization with a display image, and a method for driving the display device.

2. Description of Related Art

A display device can be classified into a non-self-emissive device that displays an image by receiving light from a backlight unit using a light receiving element and a self-emissive device that displays an image using a self-emissive element. A liquid crystal display that is one of the non-self-emissive devices displays an image by varying light transmittance of each pixel using dielectric anisotropic properties of liquid crystal whose twisting angle varies depending on an applied voltage.

A liquid crystal display includes a liquid crystal (LC) panel assembly and a backlight unit for emitting light toward the LC panel assembly. The LC panel assembly receives light emitted from the backlight unit and selectively transmits or blocks the light using a liquid crystal layer.

The backlight unit is classified according to a light source into different types, one of which is a cold cathode fluorescent lamp (CCFL). The CCFL is a linear light source that can uniformly emit light to the LC panel assembly through an optical member such as a diffusion sheet, a diffuser plate, and/or a prism sheet.

However, since the CCFL emits the light through the optical member, there may be a light loss. In the CCFL type liquid crystal display, only 3-5% of light generated from the CCFL is transmitted through the LC panel assembly. Furthermore, since the CCFL has relatively higher power consumption, the overall power consumption of the liquid crystal display employing the CCFL increases. In addition, since the CCFL is difficult to be large-sized due to its structural limitation, it is hard to apply CCFL to a large-sized liquid crystal display over 30-inch.

A backlight unit employing light emitting diodes (LEDs) is also well known. The LEDs are point light sources that are combined with optical members such as a reflection sheet, a light guiding plate (LGP), a diffusion sheet, a diffuser plate, a prism sheet, and/or the like, thereby forming the backlight unit. The LED type backlight unit has high response time and good color reproduction. However, the LED is costly and increases an overall thickness of the liquid crystal display.

Therefore, in recent years, a field emission type backlight unit that emits light using electron emission caused by an electric field has been developed to replace the CCFL and LED type backlight units. The field emission type backlight unit is a surface light source, which has relatively low power consumption and can be designed to have a large size. Furthermore, the field emission type backlight unit does not require a number of optical members.

A typical field emission type backlight unit includes a vacuum envelope having front and rear substrates and a sealing member, cathode electrodes and electron emission regions provided on a surface of the rear substrate, and a phosphor layer and anode electrode provided on a surface of the front substrate.

An electric field is formed around each electron emission region by a voltage difference between the cathode and anode electrodes to emit electrons from the electron emission regions. The electrons collide with a corresponding portion of the phosphor layer to excite the phosphor layer.

However, all of the conventional backlight units including the field emission type backlight unit maintain a uniform brightness all over the light emission area when the liquid crystal display is driven. Therefore, it is difficult to improve the display quality to a sufficient level.

Therefore, it is desirable to provide a backlight unit that can overcome the shortcomings of the conventional backlight units to improve the dynamic contrast of the image displayed by the liquid crystal display.

### SUMMARY OF THE INVENTION

Exemplary embodiments in accordance with the present invention provide a display device that can realize an improved display quality by improving the dynamic contrast and a method of driving the display.

Exemplary embodiments in accordance with the present invention provide a display device that can reduce power consumption and minimize a light loss that may be caused by an optical member and a method of driving the display.

According to an exemplary embodiment of the present invention, a display device includes: a display panel assembly having a plurality of pixels arranged in rows and columns; and a backlight unit disposed behind the display panel assembly and having a plurality of pixels arranged in rows and columns, a number of the pixels of the backlight unit being less than a number of the pixels of the display panel assembly, wherein the backlight unit includes a plurality of scan electrodes arranged along one of row and column directions and a plurality of data electrodes arranged along the other of the row and column directions. The pixels of the backlight unit are adapted to emit lights having intensities in accordance with gray levels of the pixels of the display panel assembly.

The number of pixels of the display panel assembly in each row may be greater than or equal to 240, and the number of pixels of the display panel assembly in each column, may be greater than or equal to 240.

The number of pixels of the backlight unit in each row may be one of numbers ranging from 2 to 99, and the number of pixels of the backlight unit in each column, may be one of numbers ranging from 2 to 99. Each pixel of the backlight unit may have a length of 2-50 mm along the row direction and/or the column direction.

The display panel assembly and the backlight unit may satisfy the following condition: 240≦(the number of pixels of the display panel assembly)/(the number of pixels of the backlight unit)≦5,852.

According to another exemplary embodiment of the present invention, a display device includes: a display panel assembly having a plurality of pixels arranged in rows and columns; and a backlight unit disposed behind the display panel assembly and having a plurality of pixels arranged in rows and columns, a number of the pixels of the backlight unit being less than a number of the pixels of the display panel assembly. The backlight unit includes: front and rear substrates facing each other and forming a vacuum vessel; a plurality of scan electrodes arranged along one of row and column directions; a plurality of data electrodes arranged along the other of the row and column directions, the pixels of the backlight unit being defined by the scan electrodes and data electrodes; and a phosphor layer disposed on a surface of the front substrate facing the rear substrate.

The pixels may include electron emission regions. Each electron emission region may be formed of a material including at least one of a carbon-based material or a nanometer-sized material. The backlight unit may further include an insulating layer interposed between the scan electrodes and the data electrodes.

The scan electrodes and the data electrodes form a plurality of crossed regions and each pixel of the backlight unit may correspond to one crossed region of the scan electrodes and the data electrodes. Alternatively, each pixel of the backlight unit may correspond to two or more crossed regions of the scan electrodes and the data electrodes.

According to yet another exemplary embodiment of the present invention, a display device includes: a display panel assembly having a plurality of first scan lines for transmitting a first scan signal, a plurality of first data lines for transmitting a first data signal, and a plurality of first pixels defined by the first scan lines and the first data lines, each of the first pixels having a pixel circuit; and a backlight unit having a plurality of second scan lines for transmitting a second scan signal, a plurality of second data lines for transmitting a second data signal, and a plurality of second pixels defined by the second scan lines and the second data lines. Each of the second pixels corresponds to at least two of the first pixels, and is adapted to emit light in accordance with a highest gray level among gray levels of corresponding said at least two of the first pixels.

According to yet another exemplary embodiment of the present invention, a method of driving a display device is provided. The display device includes: a display panel assembly having a plurality of first scan lines for transmitting a first scan signal, a plurality of first data lines for transmitting a first data signal, and a plurality of first pixels defined by the first scan lines and the first data lines, each of the first pixels having a pixel circuit; and a backlight unit having a plurality of second scan lines for transmitting a second scan signal, a plurality of second data lines for transmitting a second data signal, and a plurality of second pixels defined by the second scan lines and the second data lines, wherein each of the second pixels corresponds to at least two of the first pixels, and is adapted to emit light in accordance with a highest gray level among gray levels of corresponding said at least two of the first pixels. The method includes: transmitting the second scan signal to the second scan line coupled to one of the second pixels when the first scan signal is initially applied to one of said at least two of the first pixels during a first period where the first scan signal is applied to said at least two of the first pixels corresponding to the one of the second pixels; and transmitting the second data signal to the second data line coupled to the one of the second pixels when the first data signal is initially transmitted to one of the corresponding said at least two of the first pixels.

According to yet another exemplary embodiment of the present invention, a display device includes: a display panel assembly having a plurality of pixels arranged in rows and columns; and a backlight unit disposed behind the display panel assembly and having a plurality of pixels arranged in rows and columns, a number of the pixels of the backlight unit being less than a number of the pixels of the display panel assembly. The backlight unit is adapted such that different ones of the pixels can concurrently emit lights having different intensities.

### BRIEF DESCRIPTION OF THE DRAWINGS

A more complete appreciation of the present invention and many of the attendant features and advantages thereof, will be readily apparent as the present invention becomes better understood by reference to the following detailed description when considered in conjunction with the accompanying drawings in which like reference symbols indicate like components, wherein:

FIG. 1 is an exploded perspective view of a display device according to an embodiment of the present invention;

FIG. 2 is a partially broken perspective view of a display panel assembly of FIG. 1;

FIG. 3 is a partially broken perspective view of a backlight unit according to an embodiment of the present invention;

FIG. 4 is a partial sectional view of an electron emission unit and a fourth substrate that are depicted in FIG. 3;

FIG. 5 is a top view of an electron emission unit of a backlight unit according to another embodiment of the present invention;

FIG. 6 is a partially broken perspective view of a backlight unit according to another embodiment of the present invention;

FIG. 7 is a block diagram of a driving unit for driving a display device according to an embodiment of the present invention; and

FIG. 8 is a view illustrating driving waveforms of a display device according to an embodiment of the present invention.

### DETAILED DESCRIPTION

The present invention will now be described more fully with reference to the accompanying drawings, in which exemplary embodiments of the invention are shown. The invention may, however, be embodied in many different forms and should not be construed as being limited to the embodiments set forth herein; rather these embodiments are provided so that this disclosure will be thorough and complete, and will fully convey the concept of the invention to those skilled in the art.

In the following description, a liquid crystal display will be illustrated as an example of a display device of an embodiment of the present invention. However, the present invention is not limited to this example. That is, the concept of the present invention can be applied to a non-self-emissive display device, which displays an image by receiving light from a backlight unit using a light receiving element.

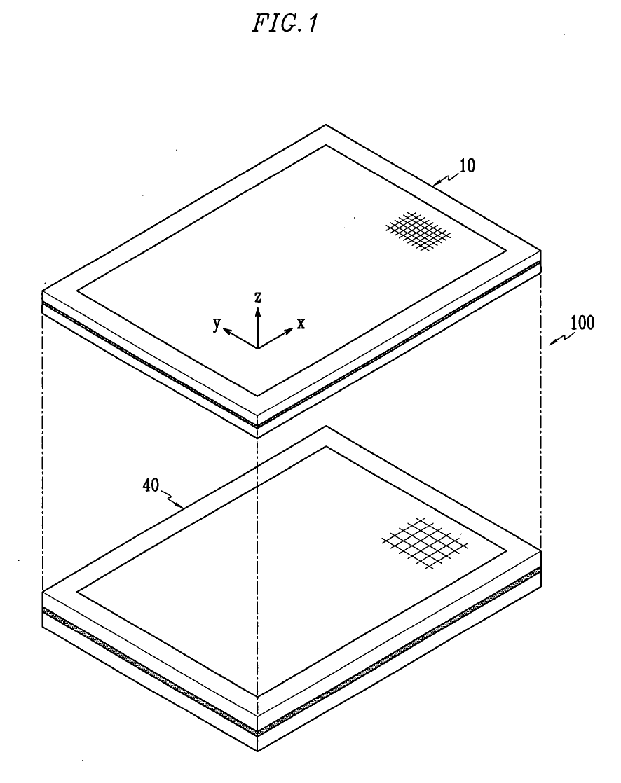

FIG. 1 is an exploded perspective view of a liquid crystal display according to an embodiment of the present invention.

Referring to FIG. 1, a liquid crystal display 100 includes a liquid crystal (LC) panel assembly 10 having a plurality of pixels arranged along rows and columns and a backlight unit 40 having a plurality of pixels. The number of pixels in the backlight unit 40 is less than the number of pixels of the LC panel assembly 10. The backlight unit 40 is installed in rear of (or behind) the LC panel assembly 10 to emit light toward the LC panel assembly 10.

The rows are defined in a horizontal direction (i.e., in a direction of an x-axis in FIG. 1) of the liquid crystal display 100 (e.g., a screen of the LC panel assembly 10). The columns are defined in a vertical direction (i.e., in a direction of a y-axis in FIG. 1) of the liquid crystal display 100 (e.g., a screen of the LC panel assembly 10).

When the number of pixels arranged along a row of the LC panel assembly 10 is M and the number of pixels arranged along a column of the LC panel assembly 10 is N, the resolution of the LC panel assembly 10 can be represented as M×N. When the number of pixels arranged along a row of the backlight unit 40 is M′ and the number of pixels arranged along a column of the backlight unit 40 is N′, the resolution of the backlight unit 40 can be represented as M′×N′.

In this embodiment, the number of pixels M can be defined as a positive number greater than or equal to 240 and the number of pixels N can also be defined as a positive number greater than or equal to 240. The number of pixels M′ can be defined as one of the positive numbers ranging from 2 to 99 and the number of pixels N′ can also be defined as one of the positive numbers ranging from 2 to 99. The backlight unit 40 is an emissive display panel having an M′×N′ resolution.

Therefore, one pixel of the backlight unit 40 corresponds to two or more pixels of the LC panel assembly 10. The pixels of the backlight unit 40 are independently controlled in their on/off operations and light emission intensity by scan electrodes and data electrodes crossing the scan electrodes at substantially right angles.

For example, when the LC panel assembly is driven to display an image having a bright portion and a dark portion in response to an image signal, it is possible to realize an image having a more improved dynamic contrast since the backlight unit 40 can emit lights having different intensities to pixels of the LC panel assembly 10 displaying the dark and bright portions.

In the described embodiment, one pixel of the backlight unit 40 has an array of field emission array (FEA) type electron emission elements.

The FEA type electron emission element includes a data electrode and a scan electrode, an electron emission region electrically connected to one of the data electrodes or the scan electrodes, and a phosphor layer. The electron emission region is formed of a material having a relatively low work function or a relatively high aspect ratio, such as a carbon-based material or a nanometer-sized material.

The FEA type electron emission element emits electrons by forming an electric field around the electron emission region using a voltage difference between the scan and data electrodes. The emitted electrons excite the phosphor layer to emit visible light having an intensity corresponding to an amount of electrons in the electron beam applied to the phosphor layer.

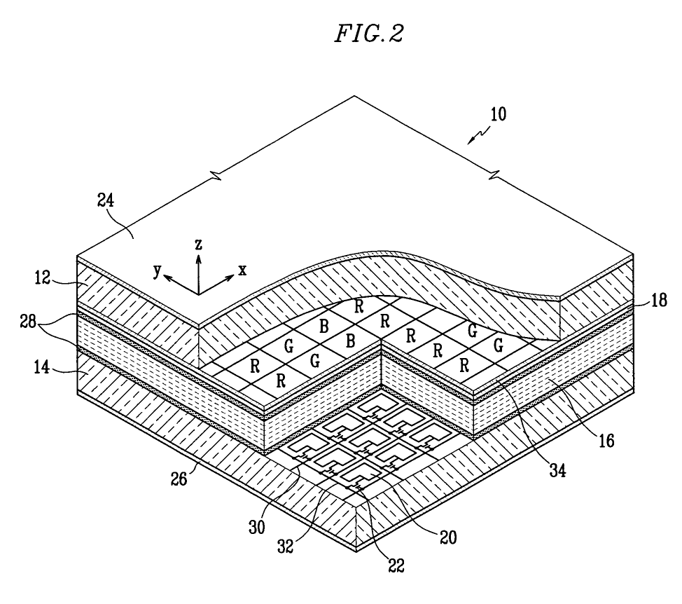

FIG. 2 is a partially broken perspective view of the LC panel assembly 10 of FIG. 1.

Referring to FIG. 2, the LC panel assembly 10 includes first and second substrates 12 and 14 facing each other, a liquid crystal (LC) layer 16 disposed between the first and second substrates 12 and 14, a common electrode 18 disposed on an inner surface of the first substrate 12, a plurality of pixel electrodes 20 disposed on an inner surface of the second substrate 14, and a plurality of switching elements 22. A sealing member (not shown) is disposed on peripheries of the first and second substrates 12 and 14.

The first and second substrates 12 and 14 are respectively front and rear substrates of the LC panel assembly 10. First and second polarizing plates 24 and 26 are respectively disposed on outer surfaces of the first and second substrates 12 and 14. The polarizing axis of the first polarizing plate 24 crosses the polarizing axis of the second polarizing plate 26 at a right angle. Orientation layers 28 are formed on the inner surfaces of the first and second substrates 12 and 14 while respectively covering the common electrodes 18 formed on the first substrate 12 and the pixel electrodes 20 and switching elements 22 formed on the second substrate 14.

A plurality of first scan lines 30 for transmitting scan signals and a plurality of first data lines 32 for transmitting data signals are formed on the inner surface of the second substrate 14. The first scan lines 30 are arranged in parallel with each other and extend along a row direction (i.e., in an x-axis direction in FIG. 2) while the first data lines 32 are arranged in parallel with each other and extend along a column direction (i.e., in a y-axis direction in FIG. 2).

The pixel electrodes 20 are formed corresponding to respective sub-pixels. A liquid crystal capacitor and a sustain capacitor as well as the switching element connected to the first scan and first data lines 30 and 32 are formed on each sub-pixel. In other embodiments, the sustain capacitor may be not used.

The switching element 22 may be formed of a thin film transistor (TFT) having a control terminal connected to the first scan line 30, an input terminal connected to the first data line 32, and an output terminal connected to the liquid crystal capacitor.

Disposed between the first substrate 12 and the common electrode 18 is a color filter assembly 34 having red, green and blue color filters each corresponding to one sub-pixel. That is, one pixel includes three sub-pixels corresponding to the red, green and blue color filters.

When the thin film transistor, i.e., the switching element 22, is turned on, an electric field is formed between the pixel electrode 20 and the common electrode 18. By the electric field, the twisting angle of the liquid crystal molecules of the LC layer 16 varies to control an amount of light transmitted through each sub-pixel, thereby realizing a predetermined color image.

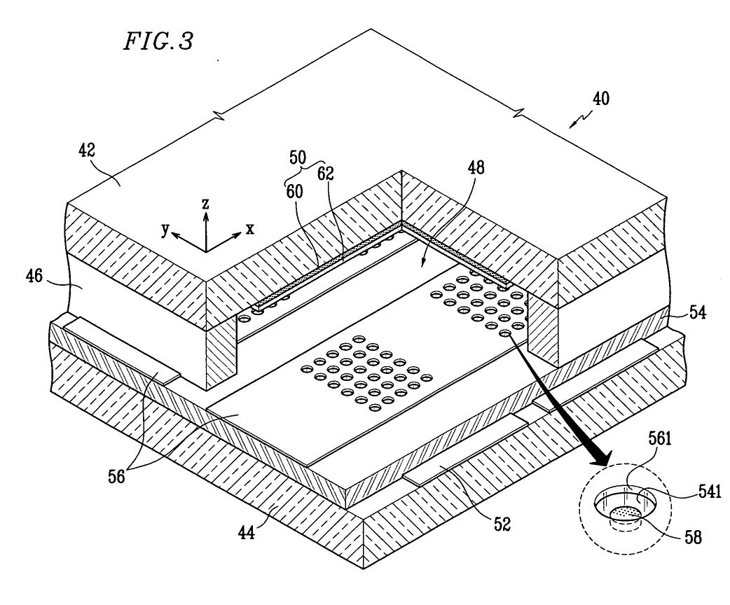

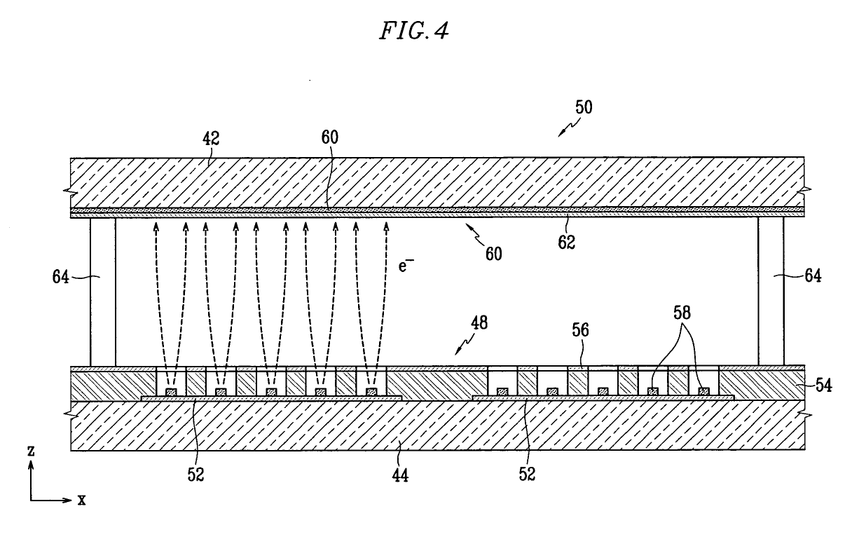

The backlight unit will now be described with reference to FIGS. 3 and 4. The backlight unit in each of the following embodiments is an electron emission display panel having an array of FEA type electron emission elements.

FIG. 3 is a partially broken perspective view of a backlight unit according to an embodiment of the present invention, and FIG. 4 is a partial sectional view of an electron emission unit and a fourth substrate that are depicted in FIG. 3.

Referring to FIGS. 3 and 4, the backlight unit 40 includes third and fourth substrates 42 and 44 facing each other with a predetermined distance between them. A sealing member 46 is provided at the peripheries of the third and fourth substrates 42 and 44 to seal them together and thus form a sealed vessel. The interior of the sealed vessel is kept to a degree of vacuum of about 10⁻⁶ Torr. Hence, the substrates 42, 44 and the sealing member 46 can be said to form a vacuum envelope or a vacuum vessel.

The third substrate 42 is a front substrate of the backlight unit 40, which faces the LC panel assembly while the fourth substrate 44 is a rear substrate. The electron emission unit 48 is provided on an inner surface of the fourth substrate 44, and a light emission unit 50 is provided on an inner surface of the third substrate 42.

The electron emission unit 48 includes first electrodes 52 arranged in a stripe pattern running in a first direction (i.e., y-axis direction of FIG. 3) of the fourth substrate 44, second electrodes 56 arranged in a stripe pattern for crossing the first electrodes 52, an insulating layer 54 interposed between the first electrodes 52 and the second electrodes 56, and electron emission regions 58 electrically connected to the first electrodes 52. In other embodiments, the electron emission regions 58 may be electrically connected to the second electrodes 56.

When the electron emission regions 58 are formed on the first electrodes 52 as shown in FIG. 3, the first electrodes 52 are cathode electrodes for applying a current to the electron emission regions 58 and the second electrodes 56 are gate electrodes for inducing the electron emission by forming the electric field around the electrode emission regions 58 according to a voltage difference between the cathode and gate electrodes. On the contrary, when the electron emission regions 58 are formed on the second electrodes 56, the second electrodes 56 are the cathode electrodes and the first electrodes 52 are the gate electrodes.

Among the first and second electrodes 52 and 56, the electrodes arranged along rows of the backlight unit 40 function as scan electrodes and the electrodes arranged along columns function as data electrodes.

In FIGS. 3 and 4, an example where the electron emission regions 58 are formed on the first electrodes 52, the first electrodes 52 are arranged along the columns (i.e., in a direction of y-axis in the drawings) of the backlight unit 40, and the second electrodes 56 are arranged along the rows (i.e., in a direction of x-axis in the drawings) of the backlight unit 40, is illustrated. However, the arrangements of the electron emission regions 58 and the first and second electrodes 52 and 56 are not limited to the above case.

The electron emission regions 58 are formed on the first electrodes 52 at crossed regions of the first and second electrodes 52 and 56. Openings 541 and 561 corresponding to the respective electron emission regions 58 are respectively formed through the insulating layer 54 and the second electrodes 56 to expose the electron emission regions 58 on the fourth substrate 44.

The electron emission regions 58 are formed of a material that emits electrons when an electric field is applied thereto under a vacuum condition, such as a carbonaceous material or a nanometer-sized material. The electron emission regions 58 can be formed of carbon nanotubes, graphite, graphite nanofibers, diamonds, diamond-like carbon, C₆₀, silicon nanowires or a combination thereof. The electron emission regions 58 can be formed through a screen-printing process, a direct growth, a chemical vapor deposition, or a sputtering process, for example.

Alternatively, the electron emission regions can be formed in a tip structure formed of a Mo-based or Si-based material.

The light emission unit 50 provided on the third substrate 42 includes a phosphor layer 60 and an anode electrode 62 formed on the phosphor layers 60. The phosphor layer 60 may be a white phosphor layer or a combination of red, green and blue phosphor layers.

The white phosphor layer may be formed on an entire active area of the third substrate 42 or divided into a plurality of sections corresponding to the respective pixels. In one embodiment, the red, green and blue phosphor layers are formed corresponding to each of the pixel regions. In FIGS. 3 and 4, the white phosphor layer is formed on the entire active area of the third substrate 42.

The anode electrode 62 can be formed of a metallic material such as aluminum and formed on the phosphor layer 60. The anode electrode 62 receives a high voltage required for accelerating the electron beams, and reflects the visible light rays radiated from the phosphor layer 60 toward the fourth substrate 44 to the third substrate 42, thereby enhancing the screen luminance.

The FEA type electron emission element defines one pixel including the first and second electrodes 52 and 56, the electron emission regions 58, and the phosphor layer 60 corresponding to the electron emission regions 58.

When driving voltages are applied to the first and second electrodes 52 and 56, an electric field is formed around the electron emission regions 58 at pixel regions where a voltage difference between the first and second electrodes 52 and 56 is higher than a threshold value, thereby emitting electrons from the electron emission regions 58. The emitted electrons are accelerated by a high voltage applied to the anode electrode 62 to collide with specific portions of the phosphor layer 60, thereby exciting the specific portions of the phosphor layer 60. A light emission intensity of the phosphor layer 60 at each pixel corresponds to an electron emission amount of the corresponding pixel.

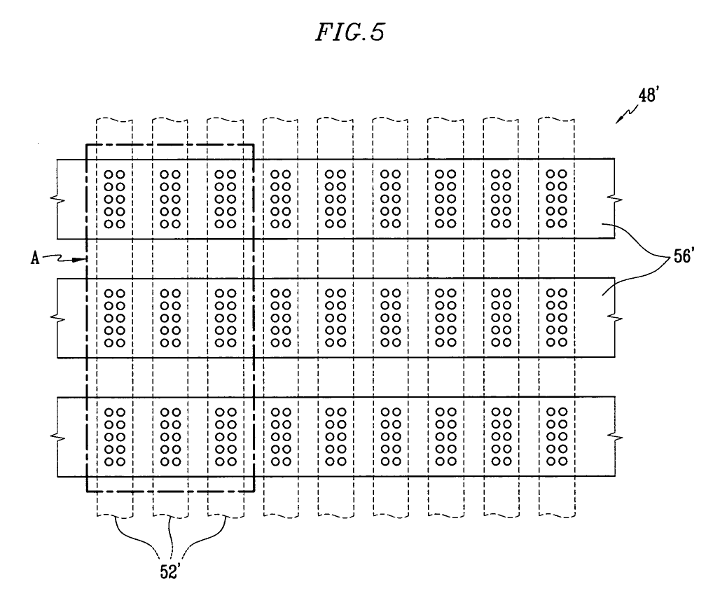

FIG. 5 is a top view of an electron emission unit 48′ of a backlight unit according to another embodiment of the present invention.

Referring to FIG. 5, one pixel region A is formed by a combination of two or more crossed regions of first and second electrodes 52′ and 56′. At this point, two or more first electrodes 52′ are electrically connected to each other and thus receive an identical driving voltage. Two or more second electrodes 56′ are also electrically connected to each other and thus receive an identical driving voltage.

To achieve the above, the two or more first electrodes 52′ and the two or more second electrodes 56′ extend to an edge of the fourth substrate on which the electrodes are located. Then, extended ends of the two or more first electrodes 52′ are connected to each other using (e.g., by being mounted on) a coupling member such as a flexible printed circuit board (FPCB). Likewise, extended ends of the two or more second electrodes 56′ are connected to each other using (e.g., by being mounted on) another coupling member such as an FPCB.

In FIG. 5, a case where three first electrodes 52′ and three second electrodes 56′ cross each other such that nine crossed regions define one pixel region A is illustrated as an example.

Referring back to FIG. 4, disposed between the third and fourth substrates 42 and 44 are spacers 64 for uniformly maintaining a gap between the third and fourth substrates 42 and 44 against an external force or pressure.

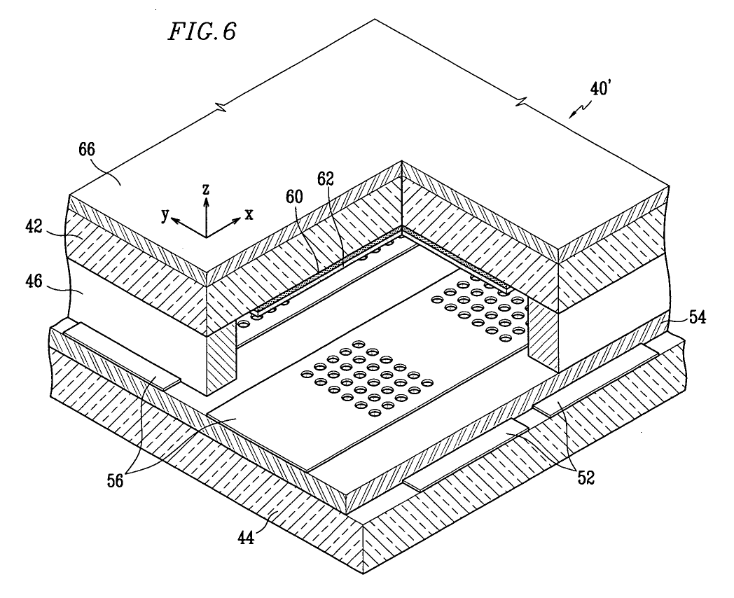

In one embodiment, the third substrate 42, which is a front substrate, has a light diffusion function so that it can serve as a diffuser plate. In other embodiments, as shown in FIG. 6, a diffuser plate 66 is disposed on the outer surface of the third substrate 42.

As described above, the liquid crystal display 100 of the present invention in one embodiment utilizes a low-resolution display panel as the backlight unit 40. That is, the backlight unit 40 has pixels, the number of which is less than that of the LC panel assembly 10. The backlight unit 40 is driven in a passive matrix manner using the scan and data electrodes. The pixels of the backlight unit 40 provide different light intensities to the corresponding pixels of the LC panel assembly 10.

A test for identifying a display quality of the LC panel assembly 10, a cost for manufacturing a driving circuit unit, and an easiness of manufacturing the LC panel assembly 10 was conducted while varying the number of pixels of the backlight unit 40. According to the test results, the optimum number of pixels of the backlight unit 40 for each resolution of the LC panel assembly 10 was obtained as shown in the following table 1.

TABLE 1

| | | | (The Number |
|---|---|---|---|
| | | | of Pixels of |
| Resolution | | | LC Panel |
| of LC | The Number of | The Number of | Assembly)/(The |
| Panel assembly | Pixels of LC | Pixels of | Number of Pixels of |
| (M × N) | Panel Assembly | Backlight Unit | Backlight Unit) |
| 320 × 240 | 76,800 | 25–300 | 256–3,072 |
| 640 × 400 | 256,000 | 100–1,000 | 256–2,560 |
| 640 × 480 | 307,200 | 100–1,200 | 256–3,072 |
| 800 × 480 | 384,000 | 160–1,500 | 256–2,400 |
| 800 × 600 | 480,000 | 256–2,000 | 240–1,875 |
| 1024 × 600 | 614,400 | 144–640 | 960–4,270 |
| 1024 × 768 | 786,432 | 144–768 | 1,024–5,464 |
| 1280 × 768 | 983,040 | 192–960 | 1,024–5,120 |
| 1280 × 1024 | 1,310,720 | 256–1,280 | 1,024–5,120 |
| 1366 × 798 | 1,090,068 | 256–1,344 | 812–4,260 |
| 1400 × 1050 | 1,470,000 | 320–1,728 | 852–4,600 |
| 1600 × 1200 | 1,920,000 | 400–2,000 | 950–5,760 |
| 1920 × 1200 | 2,304,000 | 400–2,400 | 960–5,760 |
| 2048 × 1536 | 3,145,728 | 576–3,072 | 1,024–5,462 |
| 2560 × 2048 | 5,242,880 | 896–5,120 | 1,024–5,852 |
| 3200 × 2400 | 7,680,000 | 1,440–7,500 | 1,024–5,334 |

As shown in Table 1, it can be noted that (The Number of Pixels of LC Panel Assembly)/(The Number of Pixels of Backlight Unit) in one embodiment is preferably within a range of 240 to 5,852. In the described embodiment, by maintaining this ratio within the range of 240 to 5,852, the manufacturing cost for the backlight unit is kept from becoming unduly high due to manufacturing difficulties, while the dynamic contrast is prevented from deteriorating excessively. In other embodiments, the preferred ratio between the number of pixels of LC panel assembly and the number of pixels of the backlight unit may be different.

In one embodiment, each pixel of the backlight unit 40 may be formed having a length of 2-50 mm along the row direction and/or the column direction. In the described embodiment, by maintaining the length of each pixel within the range of 2 mm to 50 mm, the number of pixels of the backlight unit is kept from unduly increasing so as to make it difficult to process the circuit signals, while the display quality is prevented from deteriorating excessively. In other embodiments, the pixels may have different lengths.

When the liquid crystal display 100 has the above-described backlight unit 40, a variety of features and/or advantages can be expected.

For example, since the backlight unit 40 of the present embodiment is the surface light source, it does not require a plurality of optical members that have been used in the CCFL type backlight unit and the LED type backlight unit. Therefore, there is no light loss associated with the light passing through the optical members, in the backlight unit 40 of this embodiment. Thus, there is no need to emit light having an excessive intensity from the backlight unit 40, thereby reducing the power consumption.

In addition, since no optical member is used in the backlight unit 40, the manufacturing cost of the backlight unit 40 can be reduced. Furthermore, since the backlight unit 40 can be easily made to have a large size, it can be effectively applied to the large-sized liquid crystal display over 30-inch.

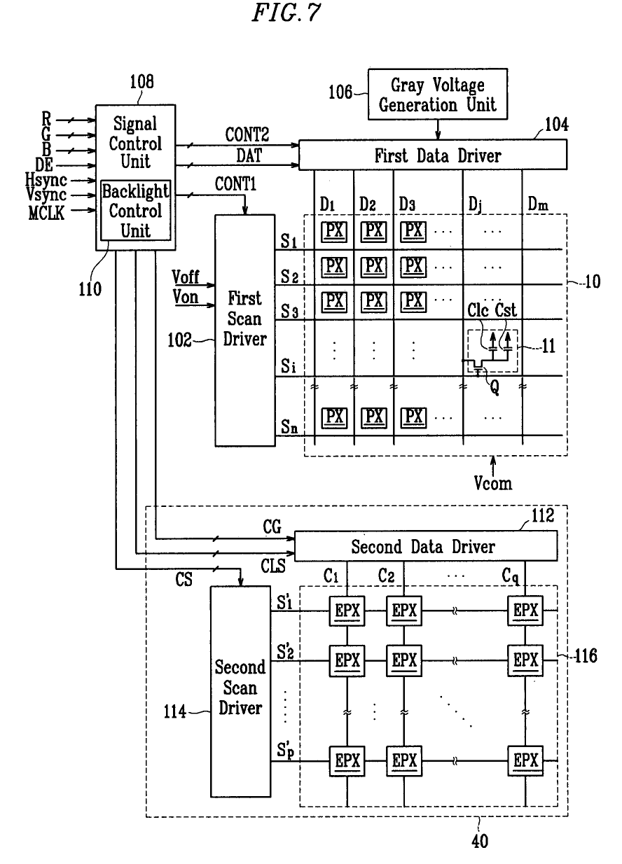

FIG. 7 is a block diagram of a driving part of the display device according to an embodiment of the present invention. The display device according to an embodiment of the present invention is a liquid crystal display, but the present invention is not limited to a liquid crystal display.

Referring to FIG. 7, a driving part of the liquid crystal display includes a first scan driver 102 and a first data driver 104 connected to the LC panel assembly 10, a gray voltage generation unit 106 connected to the first data driver 104, and a signal control unit 108 for controlling the first scan and first data drivers 102 and 104 as well as a backlight unit 40.

When considering the LC panel assembly 10 as an equivalent circuit, the LC panel assembly 10 includes a plurality of signal lines and a plurality of first pixels PX arranged along rows and columns and connected to the signal lines. The signal lines include a plurality of first scan lines S₁-Sₙ for transmitting first scan signals and a plurality of first data lines D₁-Dₘ for transmitting first data signals.

Each first pixel, e.g., a pixel 11 connected to an iₜₕ (i=1, 2, . . . n) first scan line Sᵢ and a iₜₕ (j=1, 2, . . . m) first data line Dⱼ, includes a switching element Q connected to the iₜₕ first scan line Sᵢ and the iₜₕ first data line Dⱼ, and liquid crystal and sustain capacitors Clc and Cst. In other embodiments, the sustain capacitor Cst may be not used.

The switching element Q is a 3-terminal element such as a thin film transistor (TFT) formed on a second substrate (see FIG. 2, for example) of the LC panel assembly 10. That is, the switching element Q includes a control terminal connected to the first scan line Sᵢ, an input terminal connected to the first data line Dⱼ, and an output terminal connected to the liquid crystal and sustain capacitors Clc and Cst.

The gray voltage generation unit 106 generates two sets of gray voltages (or two sets of reference gray voltages) related to the transmittance of the first pixels PX. One of the two sets has a positive value with respect to a common voltage Vcom and the other has a negative value.

The first scan driver 102 is connected to the fist scan lines S₁-Sₙ of the LC panel assembly 10 to apply a first scan signal that is a combination of a switch-on-voltage Von and a switch-off-voltage Voff, to the first scan lines S₁-Sₙ.

The first data driver 104 is connected to the first data lines D₁-Dₘ of the LC panel assembly 10. The first data driver 104 selects a gray voltage from the gray voltage generation unit 106 and applies the selected gray voltage to the first data lines D₁-Dₘ. However, when the gray voltage generation unit 106 does not provide all of the voltages for all of the gray levels but provides only a predetermined number of reference gray voltages, the first data driver 104 divides the reference gray voltages, generates the gray voltages for all of the gray levels, and selects a first data signal from the gray voltages.

The signal control unit 108 controls the first scan and first data drivers 102 and 104, and includes a backlight control unit 110 for controlling the backlight unit 40. The backlight control unit 110 controls a second scan driver 114 and a second data driver 112 of the backlight unit 40. The signal control unit 108 receives input image signals R, G and B and an input control signal for controlling the display of the image from an external graphic controller (not shown).

The input image signals R, G and B have luminance information of each first pixel PX. The luminance has a predetermined number of gray levels (e.g., 1024 or 256 gray levels). The input control signal may be one or more of a vertical synchronizing signal Vsync, a horizontal synchronizing signal Hsync, a main clock signal MCLK, or a data enable signal DE.

The signal control unit 108 properly processes the input image signals R, G and B in response to the operating condition of the LC panel assembly 10 with reference to the input control signal, generates a first scan driver control signal CONT1 and a first data driver control signal CONT2. The signal control unit 108 transmits the first scan driver control signal CONT1 to the first scan driver 102, and transmits the first data driver control signal CONT2 and the processed image signal DAT to the first data driver 104.

The first scan driver control signal CONT1 includes a gate clock signal and a start vertical signal (STS). The gate clock signal is transmitted to the first scan driver. The gate clock signal has a period same as that of the horizontal synchronizing signal Hsync and a switch-on voltage is applied to each of the first scan lines Sᵢ-Sₙ for each cycle of the gate clock signal.

A display portion 116 of the backlight unit 40 includes a plurality of second pixels EPX, each of which is connected to one of second scan lines S′₁-S′ₚ and one of second data lines C₁-C_{q}. Each second pixel EPX emits light according to a difference between the voltages applied to the corresponding one of the second scan lines S′₁-S′ₚ and the corresponding one of the second data lines C₁-C_{q}. The second scan lines S′₁-S′ₚ correspond to the scan electrodes of the backlight unit 40 and the second data lines C₁-C_{q} correspond to the data electrodes of the backlight unit 40.

The backlight control unit 110 detects the highest gray level among gray levels of the plural first pixels PX corresponding to one second pixel EPX of the backlight unit using the image signal DAT with respect to the first pixels PX corresponding to one second pixel EPX of the backlight unit, calculates the gray level of the second pixel EPX corresponding to the detected highest gray level, converts the calculated gray level into digital data, and transmits a light emission signal CLS to the second data driver 112. The light emission signal CLS according to one embodiment of the present invention includes digital data having at least 6 bits, depending on the gray level of the second pixel EPX. In addition, the backlight control unit 110 generates a second scan driver control signal CS using a gate control signal. The backlight control unit 110 generates a second data driver control signal CD using the data control signal CONT2 and transmits the second data driver control signal CD to the second data driver 112.

The second scan driver 114 is connected to a plurality of second scan lines S′1-S′p. The second scan driver 114 transmits scan signals to the gate electrodes so that each second pixel EPX can emit light in synchronization with the corresponding first pixels PX according to the second scan driver control signal CS.

The second data driver 112 is connected to a plurality of second data lines C1-Cq. The second data driver 112 controls each second pixel EPX such that the second pixel EPX emits in response to the gray level of the corresponding first pixels PX according to the light emission signal CLS and the second data driver control signal. In addition, the second data driver 112 generates a plurality of second data signals and transmits the second data signals to the second data lines C1-Cq. That is, the second data driver 112 synchronizes the second pixel EPX in response to the image displayed by the corresponding first pixels PX.

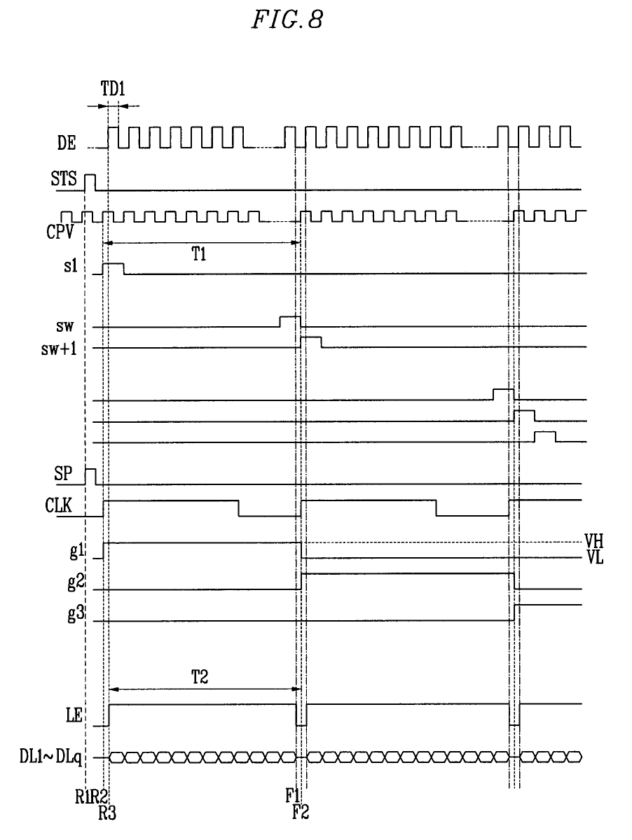

The operation of the display device according to the exemplary embodiment of the present invention will now be described with reference to FIG. 8. The data drive signal CONT2 includes a data enable signal DE. The first data driver 104 outputs data signals D1-Dm while the data enable signal DE is in a high level section.

FIG. 8 illustrates the data enable signal DE, a gate clock signal CPV, first scan signals s1-sn, second scan signals g1-g3, and a light emission enable signal LE.

As shown in FIG. 8, the first scan signals s1-sn are synchronized with a rising edge time to have the switch-on voltage during one cycle of the gate clock signal CPV. As the start vertical signal STS is a signal for outputting the switch-on voltage, the switch-on voltage is generated starting from a rising edge time (R2) of a next gate clock signal after the start vertical signal STS is generated.

The backlight control unit 110 generates the first scan drive signal CS by detecting the gate clock signal CPV of the first pixels PX corresponding to each second pixel EPX in each line. That is, the backlight control unit 110 calculates a duration T1 for which the gate signals correspond to the second pixels in one line. Then, the backlight control unit 110 generates the first clock signal CLK in synchronization with the rising edge time of the first scan signal s1 by using the calculated duration T1 as a cycle. In addition, at the time R1, the backlight control unit 110 detects the STS and generates the first pulse SP in synchronization with the start vertical signal STS. The second scan driver control signal CS includes the first clock signal CLK and the first pulse SP.

Then, as can be seen in FIGS. 7 and 8, the second scan signal g1 output by the second scan driver 114 becomes a first level VH in synchronization with the first scan signal s1 transmitted to the LC panel assembly 10 according to the second scan driver control signal CS including the first pulse SP and the first clock signal CLK. The second scan driver 114 generates a second scan signal g1 having a second level VL in synchronization with a falling edge time F2 of the first scan signal sw of a last line corresponding to the second pixels of the first line. In one embodiment of the present invention, the first level VH is a high level and the second level VL is a low level. Then, second scan signals g2 and g3 are sequentially generated according to the above-described process.

The backlight control unit 110 detects a duration for which the data signal is transmitted to the first pixels PX corresponding to the second pixels EPX in one line using the data enable signal DE and generates a light emission enable signal. That is, the backlight control unit 110 detects a duration T2 for which the first data signal is transmitted to the first pixels PX connected to the first scan lines corresponding to the second pixels of one line. The backlight control unit 110 generates the light emission enable signal having a third level for the detected duration. In one embodiment of the present invention, the third level is a high level.

Then, the second data driver 112 transmits the second data signal to the second data lines C1-Cq according to the second data driver control signal CD including the light emission enable signal LE.

Describing in more detail, the duration for which the data signals D1-Dm are transmitted to the first pixels in the first line among the first pixels PX corresponding to the second pixels EPX connected to the second scan line S′1 of the first line. At this point, the data enable signal DE ascends to the high level from a start time R3 of the first duration TD1 and the light emission enable signal LE is synchronized to rise to the third level at this start time R3. In addition, the light emission enable signal LE descends to a fourth level at a time F1 where the transmission of the data signals D1-Dm to the first pixels PX of the last line among the first pixels PX corresponding to the second pixels EPX connected to the second scan line S′1 of the first line. Then, the second data signals DL1-DLq are synchronized with the start time R3 and transmitted to the second data lines C1-Cq. Then, the second data signals DL1-DLq are maintained at the second data lines C1-Cq up to a time point F2. That is, the second data signals are transmitted to the second data lines C1-Cq for duration T2 so that each of the second pixels EPX emits the light according to the second data signal. Likewise, when the second scan signals g2-g3 of the first level are sequentially transmitted to the second scan lines S′2-S′p, the second data signals DL1-DLq are transmitted to the second data lines C1-Cq so that the second pixels EPX emit the light.

In this embodiment, the second data signal of the backlight unit uses a pulse amplitude modulation (PAM) method where a level of the voltage of the second data signal varies. However, the present invention is not limited to the PAM method. By way of example, a pulse width modulation (PWM) method where a pulse width of the second data signal is modulated in response to the gray level can also be used. In this case, the second data signal has a substantially constant voltage level (which may be predetermined) and is applied to the second data line during a period corresponding to the highest gray level among gray levels of the first pixels corresponding to the second pixel.

In the backlight unit according to the present invention, since the gray level of the second pixel is determined in accordance with the gray levels of the first pixels while image data of one frame is displayed on the liquid crystal panel assembly, the dynamic contrast can be enhanced.

Although exemplary embodiments of the present invention have been described in detail hereinabove, it should be clearly understood that many variations and/or modifications of the basic inventive concept taught herein still fall within the spirit and scope of the present invention, as defined by the appended claims and their equivalents.

What is claimed is:

1. A display device comprising:
a display panel assembly having a plurality of pixels arranged in rows and columns; and
a backlight unit disposed behind the display panel assembly and having a plurality of pixels arranged in rows and columns, a number of the pixels of the backlight unit being less than a number of the pixels of the display panel assembly,
wherein the backlight unit comprises a plurality of scan electrodes arranged along one of row and column directions and a plurality of data electrodes arranged along the other of the row and column directions, and
wherein the pixels of the backlight unit are adapted to emit lights having intensities in accordance with gray levels of the pixels of the display panel assembly.

2. The display device of claim 1, wherein the number of pixels of the display panel assembly in each row, is greater than or equal to 240, and the number of pixels of the display panel assembly in each column, is greater than or equal to 240.

3. The display device of claim 2, wherein the number of pixels of the backlight unit in each row, is one of numbers ranging from 2 to 99, and the number of pixels of the backlight unit in each column, is one of numbers ranging from 2 to 99.

4. The display device of claim 1, wherein each pixel of the backlight unit has a length of 2-50 mm along the row direction and/or the column direction.

5. The display device of claim 1, wherein the display panel assembly and the backlight unit satisfy the following condition:
240≦(the number of pixels of the display panel assembly)/(the number of pixels of the backlight unit)<5,852.

6. The display device of claim 1, wherein each pixel of the backlight unit includes at least a portion of one of the scan electrodes and at least a portion of one of the data electrodes.

7. The display device of claim 1, wherein each pixel of the backlight unit includes at least a portion of at least two of the scan electrodes and at least a portion of at least two of the data electrodes.

8. The display device of claim 7, wherein the at least two of the scan electrodes are electrically connected to each other and the at least two of the data electrodes are electrically connected to each other.

9. The display device of claim 1, wherein the pixels of the backlight unit are formed of Field Emission Array (FEA) type electron emission elements.

10. The display device of claim 1, wherein the pixels of the backlight unit are adapted to emit lights having different intensities.

11. A display device comprising:
a display panel assembly having a plurality of pixels arranged in rows and columns; and
a backlight unit disposed behind the display panel assembly and having a plurality of pixels arranged in rows and columns, a number of the pixels of the backlight unit being less than a number of the pixels of the display panel assembly,
wherein the backlight unit comprises:
a front substrate;
a rear substrate facing the front substrate, wherein the front and rear substrates form a vacuum vessel;
a plurality of scan electrodes arranged along one of row and column directions;
a plurality of data electrodes arranged along the other of the row and column directions, the pixels of the backlight unit being defined by the scan electrodes and the data electrodes; and
a phosphor layer disposed on a surface of the front substrate facing the rear substrate.

12. The display device of claim 11, wherein the pixels include electron emission regions, and wherein each electron emission region is formed of a material including at least one of a carbon-based material or a nanometer-sized material.

13. The display device of claim 11, further comprising an insulating layer interposed between the scan electrodes and the data electrodes.

14. The display device of claim 13, wherein the scan electrodes and the data electrodes form a plurality of crossed regions and each pixel of the backlight unit corresponds to one crossed region of the scan electrodes and the data electrodes.

15. The display device of claim 13, wherein the scan electrodes and the data electrodes form a plurality of crossed regions and each pixel of the backlight unit corresponds to two or more crossed regions of the scan electrodes and the data electrodes.

16. The display device of claim 11, wherein the phosphor layer is a white phosphor layer.

17. The display device of claim 11, wherein the phosphor layer includes red, green and blue phosphor layers.

18. The display device of claim 11, wherein the front substrate has a light diffusing function.

19. The display device of claim 11, wherein the backlight unit further comprises a diffuser plate disposed on a surface of the front substrate facing the display panel assembly.

20. The display device of claim 11, wherein the number of pixels of the display panel assembly in each row, is greater than or equal to 240, and the number of pixels of the display panel assembly in each column, is greater than or equal to 240.

21. The display device of claim 20, wherein the number of pixels of the backlight unit in each row, is one of numbers ranging from 2 to 99, and the number of pixels of the light emission device in each column, is one of numbers ranging from 2 to 99.

22. The display device of claim 11, wherein each pixel of the backlight unit has a length of 2-50 mm along the row direction and/or the column direction.

23. The display device of claim 11, wherein the display panel assembly and the backlight unit satisfy the following condition:
240≦(the number of pixels of the display panel assembly)/(the number of pixels of the backlight unit)≦5,852.

24. A display device comprising:
a display unit including a plurality of first scan lines, a plurality of first data lines, and a plurality of first pixels defined by the first scan lines and the first data lines, each of the first pixels having a pixel circuit;
a first scan driver for applying a first scan signal to each of the first scan lines;
a first data driver for applying a first data signal to each of the first data lines;
a signal control unit for receiving an image signal from an external device, generating a first scan driver control signal and a first data driver control signal corresponding to the image signal, applying the first scan driver control signal and the first data driver control signal to the first scan driver and the first data driver, respectively; and
a backlight unit including a plurality of second scan lines, a plurality of second data lines, a plurality of second pixels defined by the second scan lines and the second data lines, a second scan driver for transmitting a second scan signal to each of the second scan lines, and a second data driver for transmitting a second data signal to each of the second data lines,
wherein each of the second pixels of the backlight unit corresponds to at least two of the first pixels of the display unit.

25. The display device of claim 24, wherein the signal control unit is adapted to generate a second scan driver control signal and a second data driver control signal using the image signal.

26. The display device of claim 24, wherein the backlight unit is adapted to represent 2 to 8 bits of a gray level for each of the second pixels.

27. The display device of claim 24, wherein the second pixels are formed of Field Emission Array (FEA) type electron emission elements.

28. A display device comprising:
a display panel assembly having a plurality of first scan lines for transmitting a first scan signal, a plurality of first data lines for transmitting a first data signal, and a plurality of first pixels defined by the first scan lines and the first data lines, each of the first pixels having a pixel circuit; and
a backlight unit having a plurality of second scan lines for transmitting a second scan signal, a plurality of second data lines for transmitting a second data signal, and a plurality of second pixels defined by the second scan lines and the second data lines, wherein each of the second pixels corresponds to at least two of the first pixels, and is adapted to emit light in accordance with a highest gray level among gray levels of corresponding said at least two of the first pixels.

29. The display device of claim 28, wherein the second pixels are adapted to emit light according to a voltage difference between scan voltages applied to respective ones of the second scan lines and data voltages applied to respective ones of the second data lines.

30. The display device of claim 29, wherein the second scan signal is applied to one of the second scan lines during a first period where the first scan signal is applied to said at least two of the first pixels corresponding to the second pixel coupled to the one of the second scan lines; and
the second data signal corresponding to the highest gray level is applied to the second pixel when the first data signal is initially applied to one of the corresponding said at least two of the first pixels.

31. The display device of claim 30, wherein, when the first data signal is initially applied to one of the corresponding said at least two of the first pixels, the second data signal is applied as the data voltage to the second pixel for the highest gray level to be displayed.

32. The display device of claim 31, wherein the backlight unit is adapted to receive a light emission signal for displaying a gray level corresponding to the highest gray level among the gray levels of the corresponding said at least two of the first pixels, on the second pixel; and
the data voltage for displaying the highest gray level corresponds to the light emission signal.

33. The display device of claim 32, wherein the light emission signal is digital data having at least 6 bits.

34. The display device of claim 29, wherein the second scan signal is applied to one of the second scan lines during a first period where the first scan signal is applied to said at least two of the first pixels corresponding to the second pixel coupled to the one of the second scan lines; and
the second data signal having a substantially constant level is applied to the second pixel during a period corresponding to the highest gray level, when the first data signal is initially applied to one of the corresponding said at least two of the first pixels.

35. The display device of claim 34, wherein, when the first data signal is initially applied to one of the corresponding said at least two of the first pixels, the second data signal is applied as a predetermined data voltage to the second pixel during a period corresponding to the highest gray level.

36. The display device of claim 35, wherein the backlight unit is adapted to receive a light emission signal for displaying a gray level corresponding to the highest gray level among the gray levels of the corresponding said at least two of the first pixels on the second pixel; and
the period corresponding to the highest gray level corresponds to the light emission signal.

37. The display device of claim 36, wherein the light emission signal is digital data having at least 6 bits.

38. A method of driving a display device comprising:
a display panel assembly having a plurality of first scan lines for transmitting a first scan signal, a plurality of first data lines for transmitting a first data signal, and a plurality of first pixels defined by the first scan lines and the first data lines, each of the first pixels having a pixel circuit; and
a backlight unit having a plurality of second scan lines for transmitting a second scan signal, a plurality of second data lines for transmitting a second data signal, and a plurality of second pixels defined by the second scan lines and the second data lines,
wherein each of the second pixels corresponds to at least two of the first pixels, and is adapted to emit light in accordance with a highest gray level among gray levels of corresponding said at least two of the first pixels,
the method comprising:
transmitting the second scan signal to the second scan line coupled to one of the second pixels when the first scan signal is initially applied to one of said at least two of the first pixels during a first period where the first scan signal is applied to said at least two of the first pixels corresponding to the one of the second pixels; and
transmitting the second data signal to the second data line coupled to the one of the second pixels when the first data signal is initially transmitted to one of the corresponding said at least two of the first pixels.

39. The method of claim 38, further comprising detecting a highest gray level among gray levels of the corresponding said at least two of the first pixels, wherein the second data signal corresponding to the highest gray level is applied to the one of the second pixels.

40. The method of claim 39, further comprising generating a light emission signal for displaying a gray level corresponding to the highest gray level on the one of the second pixels, wherein the second data signal has a voltage corresponding to the light emission signal.

41. The method of claim 40, wherein the light emission signal is digital data having at least 6 bits.

42. The method of claim 38, further comprising detecting a highest gray level among the corresponding said at least two first pixels, wherein a predetermined second data signal is applied to the one of the second pixels during a first period corresponding to the highest gray level.

43. The method of claim 42, further comprising generating a light emission signal for displaying a gray level corresponding to the highest gray level on the one of the second pixels, wherein the first period corresponds to the light emission signal.

44. The method of claim 43, wherein the light emission signal is digital data having at least 6 bits.

45. A display device comprising:
a display panel assembly having a plurality of pixels arranged in rows and columns; and
a backlight unit disposed behind the display panel assembly and having a plurality of pixels arranged in rows and columns, a number of the pixels of the backlight unit being less than a number of the pixels of the display panel assembly,
wherein the backlight unit is adapted such that different ones of the pixels can concurrently emit lights having different intensities.
